(19) United States
(12) Patent Application Publication
(10) Pub. No.: US 2008/0055935 A1
(43) Pub. Date: Mar. 6, 2008

(54) Illuminating device and display device having the same

(76) Inventors: Masashi Ono, Chiba-shi (JP); Naohiro Tomita, Chiba-shi (JP)

Correspondence Address: BRUCE L. ADAMS, ESQ., SUITE 1231, 17 BATTERY PLACE, NEW YORK, NY, 10004, US

(21) Appl. No.: 11/895,493

(22) Filed: Aug. 23, 2007

(30) Foreign Application Priority Data
Aug. 30, 2006 (JP) 2006-233173
Aug. 17, 2007 (JP) 2007-213037

(51) Int. Cl. F21V 8/00; F21V 7/04

(52) U.S. Cl. 362/623

(57) ABSTRACT

A light-beam direction conversion portion including two reflecting surfaces is provided in a light guide plate so that an end of each of the reflecting surfaces is brought into contact with a light input surface of the light guide plate. A traveling direction of a light beam from a light source is converted on each of the reflecting surfaces by total reflection, so an inner portion of the light guide plate has a uniform light beam distribution even in the case where a size of the edge area is small. Therefore, each of the reflecting surfaces is provided at an angle equal to or smaller than 20.02 degrees relative to the normal to a light emitting surface of the light source.

### BACKGROUND OF THE INVENTION

1. Field of the Invention

The present invention relates to an illuminating device for illuminating non-self light emitting display elements and a display device having the illuminating device which is used for electronic equipment. In particular, the present invention relates to a liquid crystal display device used for a portable information device, a mobile telephone, a liquid crystal television, and the like.

2. Description of the Related Art

An edge-light illuminating device in which a light beam emitted from a light source is input on a side surface of a light guide plate for guiding light and then output from an upper surface of the light guide plate is used as an illuminating device for non-self light emitting display elements such as a liquid crystal display device. FIG. 2 is a schematic view showing a conventional edge-light illuminating device. As shown in FIG. 2, a light beam emitted from an LED 1 is input on a light guide plate 2, guided through an inner portion of the light guide plate 2, and output from a light output surface 8. However, a width “a” of a light emitting surface 7 of the LED 1 is narrower than a width “c” of the light guide plate 2, so the light beam emitted from the LED 1 is not uniformly spread to the width “c” of the light guide plate 2. Therefore, there is a portion having a length (edge area “d”) that the light beam cannot be uniformly emitted, with a result that an effective light output surface of the illuminating device becomes a portion obtained by removing the edge area “d” from the original light output surface 8. In order to reduce the edge area “d”, a structure in which a cutout portion which transmits a part of the light beam from the LED 1 and reflects another part thereof to the right and left to diffuse the light beam is provided on a light input surface side of the light guide plate 2 on which the light beam from the LED 1 is input is disclosed in JP 2001-035229 A (hereinafter referred to as Patent Document 1). According to the structure, the light beam is uniformly spread to shorten a length of the edge area “d”.

In the illuminating device disclosed in Patent Document 1, a transmission portion is used as the cutout portion for diffusing the light beam in order to shorten the length of the edge area “d”. In this case, the light beam travels from the light guide plate to the cutout portion and travels from the cutout portion to the light guide plate, that is, the light beam travels through two interfaces whose refractive indexes are different from each other. Therefore, a loss is caused by interface reflection to reduce the use efficiency of the light beam input on the light guide plate.

### SUMMARY OF THE INVENTION

Therefore, an object of the present invention is to realize an illuminating device in which a light beam is uniformly spread over a light guide plate without the transmission that causes a loss by interface reflection, thereby an effective light output surface whose light beam use efficiency is not reduced, an edge area length is short, and brightness unevenness is small is provided, and a display device having the illuminating device.

In order to solve the problem, an illuminating device includes a light source and a light guide plate having a light input surface on which light from the light source is input and a light output surface from which the light which is input on the light input surface and guided is output. The light guide plate includes a light beam direction conversion portion having two reflecting surfaces for reflecting the light beam from the light source. Each of the two reflecting surfaces is formed so that an end thereof is brought into contact with the light input surface and an angle relative to the normal to a light emitting surface of the light source is equal to or smaller than 20.02 degrees. That is, according to the illuminating device of the present invention, the light output surface of the light guide plate or an opposite surface thereof includes two or more reflecting surfaces each having one end in contact with the light input surface. The reflecting surfaces are formed by a cutout portion formed in at least one of the light output surface and the opposite surface or a through hole portion formed in a direction perpendicular to the light guide plate. Each of the reflecting surfaces is formed at an angle within 20.02 degrees relative to the normal to the light emitting surface of the light source. The light beam input on the light guide plate from the light source is reflected on the reflecting surfaces, so a traveling direction of the light beam is converted. Therefore, the light beam distributed in the light guide plate can be spread in a width direction of the light guide plate. One end of each of the reflecting surfaces is brought into contact with the light input surface of the light guide plate, so the traveling direction of the light beam is converted immediately after the incidence on the light input surface. Therefore, the light beam can be spread in the width direction of the light guide plate with the edge area smaller than that in the case where the reflecting surfaces are not in contact with the light input surface. When the angle of the reflecting surfaces is changed, a light beam distribution of the light guide plate can be adjusted. Thus, the illuminating device can be realized in which an effective light output surface whose light beam use efficiency is high, an edge area length is short, and brightness unevenness is small is provided.

The light beam direction conversion portion including the reflecting surfaces has a width narrower than that of the light emitting surface of the LED (light source). Therefore, a part of the input light beam from the LED travels through the light guide plate without the direction conversion of the part by the light beam direction conversion portion. When a width of the light beam direction conversion portion is adjusted, a ratio between the amount of light reflected on the reflecting surfaces and the amount of light which is not reflected thereon can be changed to control the light beam distribution of the light guide plate.

Even when the light input surface includes a light diffusion portion, as in the case of no light diffusion portion, the light beam input on the light guide plate from the light source is reflected on the reflecting surfaces, so the traveling direction of the light beam can be converted. In addition, it is possible to form the effective light output surface whose light beam use efficiency is high, an edge area length is short, and brightness unevenness is small.

The display device according to the present invention includes the illuminating device having any one of the above-mentioned structures and non-self light emitting display elements and the effective light output surface whose light beam use efficiency is high, an edge area length is short, and brightness unevenness is small is provided.

### BRIEF DESCRIPTION OF THE DRAWINGS

In the accompanying drawings:

FIG. 1 is a perspective view showing a schematic structure of a display device according to the present invention;

FIG. 2 is a perspective view showing a schematic structure of a conventional edge-light illuminating device;

FIG. 3 is a schematic plan view showing an illuminating device according to an embodiment of the present invention;

FIGS. 4A to 4G are cross sectional views showing structural examples of a light beam direction conversion portion taken along the A-A line of FIG. 3;

Next, FIGS. 5A to 5F are schematic plan views showing plane shape examples of the light beam direction conversion portion;

FIG. 6 is an explanatory enlarged view showing the action of a reflecting surface of the light beam direction conversion portion;

FIG. 7 is an enlarged view showing the case where a light reflecting surface for reflecting a light beam has an angle relative to the normal to a light emitting surface of an LED which is larger than 20.02 degrees and a width which is larger than a width of the light emitting surface of the LED;

FIG. 8 is an enlarged plan view showing a structure in which a light diffusion portion is provided to a light input portion of a light guide plate; and

FIGS. 9A and 9B are explanatory plan views showing a positional relationship between the reflecting surface and a light input surface.

### DETAILED DESCRIPTION OF THE PREFERRED EMBODIMENT

According to the present invention, an illuminating device includes a light source and a light guide plate. The light guide plate has a light input surface on which a light beam from the light source is input, a light output surface from which the light beam which is guided is output, an opposite surface opposed to the light output surface, and a light beam direction conversion portion having two reflecting surfaces each having one end in contact with the light input surface. Each of the two reflecting surfaces is a surface for reflecting the light beam from the light source and is formed at an angle which is within 20.02 degrees relative to the normal to a light emitting surface. According to the structure, it is possible to realize an illuminating device having an effective light output surface whose light beam use efficiency is high, an edge area length is short, and brightness unevenness is small, and a display device including the illuminating device.

Further, the light beam direction conversion portion has a length in a width direction thereof which is shorter than a width of the light emitting surface of the light source. That is, the width of the light emitting surface of the light source is larger than a width in the case where the two reflecting surfaces are projected to the light input surface. According to the structure, there is a light beam directly traveling to a non-light input surface side of the light guide plate without traveling through the reflecting surfaces, so the evenness of brightness on the light output surface is facilitated.

The two reflecting surfaces included in the light beam direction conversion portion are in contact with each other at one end in the light input surface. Alternatively, the two reflecting surfaces are formed so that the ends thereof are located at an interval. The interval corresponds to a gap formed in the light input surface of the light guide plate. That is, an opening portion is formed in the light input surface. One end of the opening portion is bonded to an end of one of the two reflecting surfaces and the other end of the opening portion is bonded to an end of the other of the two reflecting surfaces.

The display device according to the present invention includes the illuminating device having any one of the above-mentioned structures and non-self light emitting display elements provided on a light output surface side of the illuminating device.

Hereinafter, an illuminating device and a display device according to an embodiment of the present invention will be described with reference to the attached drawings. In this embodiment, an example of a structure in which an LED element is used as the light source and a liquid crystal panel is used as the non-self-light emitting display elements will be described.

### First Embodiment

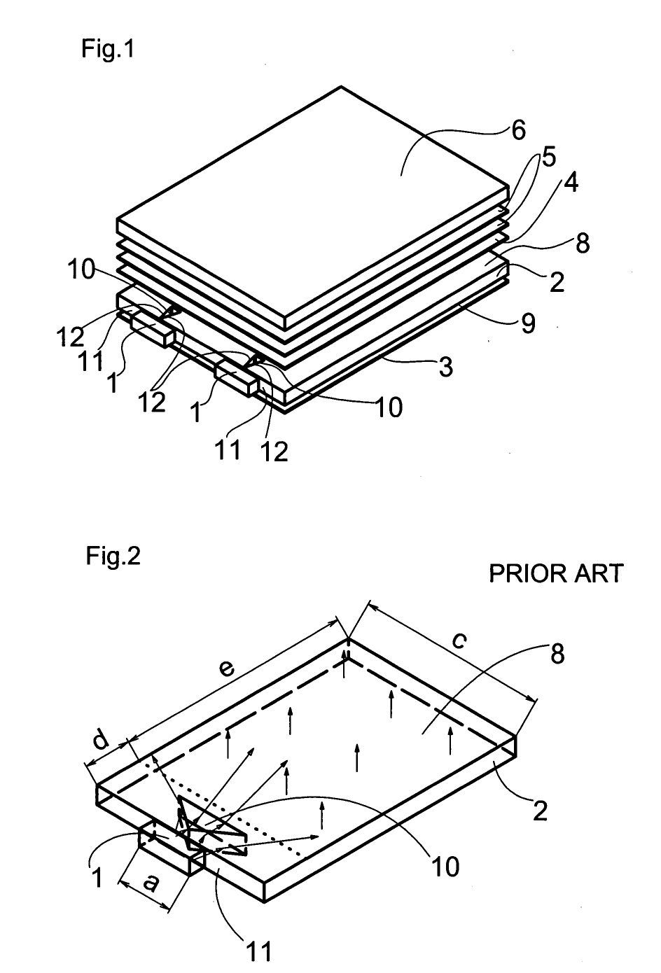

FIG. 1 is a perspective view showing a schematic structure of a display device having an illuminating device according to this embodiment. As shown in FIG. 1, a light guide plate 2 for guiding light beams emitted from LEDs 1 is disposed lateral to the LEDs 1. The light guide plate 2 has an light input surface 11 on which the light beams from the LEDs 1 are input, a light output surface 8 from which the light beams is output, and an opposite surface 9 opposed to the light output surface 8. Through hole portions perpendicular to the light guide plate are provided as light beam direction conversion portions 10 each having two reflecting surfaces which are in contact with the light input surface. That is, side surfaces formed by each of the through hole portions become the reflecting surfaces. A reflecting sheet 3 for reflecting light is disposed on an opposite surface side of the light guide plate 2. A diffusion sheet 4 for diffusing light and two prism sheets 5 for changing a traveling direction of a light beam from the diffusion sheet are disposed above the light output surface of the light guide plate 2. A liquid crystal panel 6 formed of non-self light emitting display elements is disposed above the prism sheets 5.

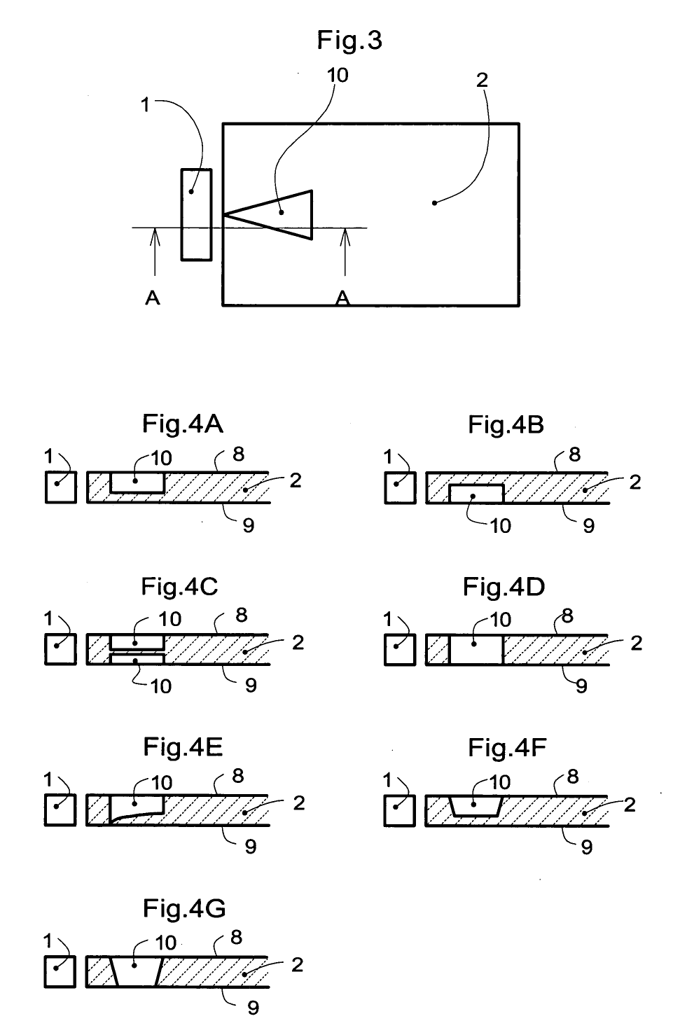

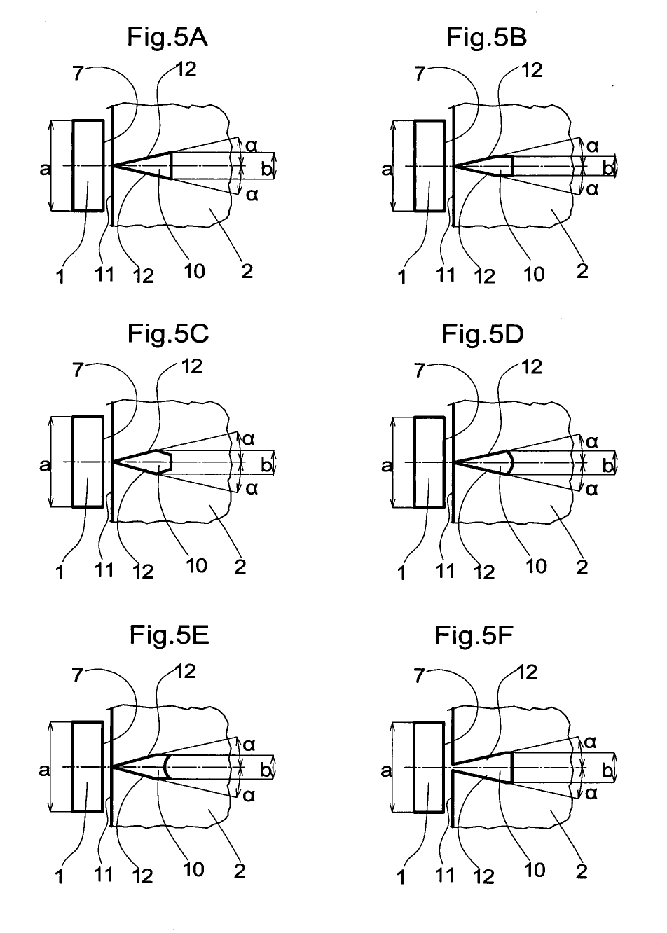

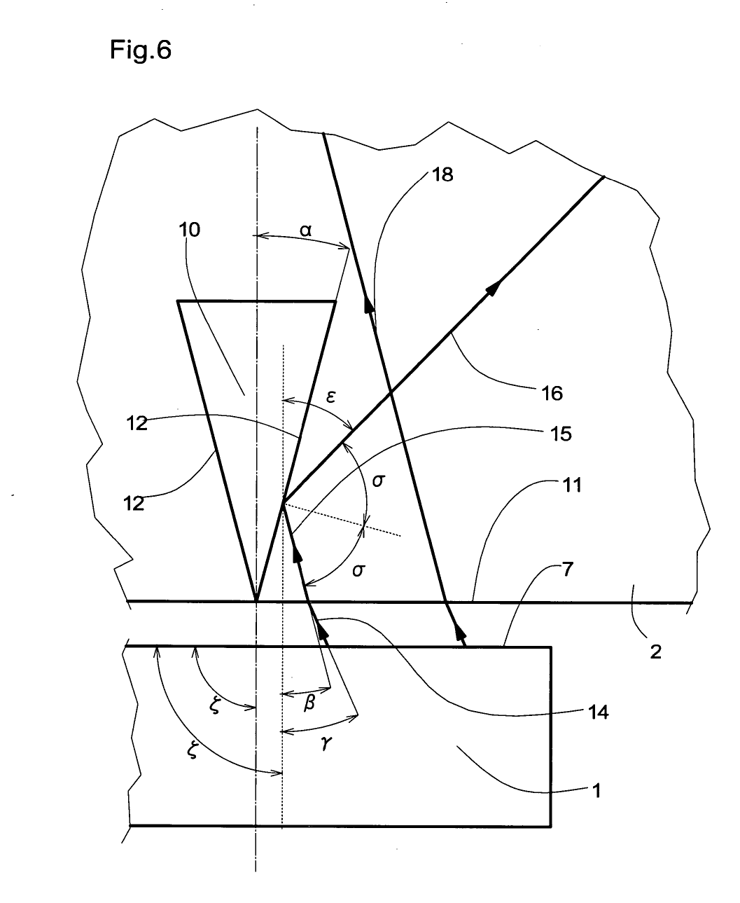

Next, a shape of the light beam direction conversion portions 10 in a cross sectional direction thereof will be described. FIG. 3 is a plan view showing the light guide plate 2 and the LED 1 in the illuminating device according to this embodiment as viewed from the light output surface side. FIGS. 4A to 4G show cross sectional examples along the line A-A of FIG. 3, which are examples of a cross sectional shape of the light beam direction conversion portion.

FIG. 4A shows the case where the light beam direction conversion portion 10 includes a cutout portion formed in the light output surface 8 side of the light guide plate 2. FIG. 4B shows the case where the light beam direction conversion portion 10 includes a cutout portion formed in the opposite surface 9 side of the light guide plate 2. FIG. 4C shows the case where the light beam direction conversion portion 10 includes two cutout portions formed in the light output surface 8 side and the opposite surface 9 side of the light guide plate 2. A depth of the cutout portion formed in the light guide plate 2 can be changed to adjust the amount of light beam whose traveling direction is converted.

FIG. 4D shows the case where the light beam direction conversion portion 10 includes a through hole portion formed in the light guide plate 2 in the perpendicular direction (thickness direction).

FIG. 4E shows the case where the light beam direction conversion portion 10 includes a cutout portion which is formed in the light output surface 8 side of the light guide plate 2 and has a nonuniform cutout depth. The cutout depth distribution of the cutout portion formed in the light guide plate 2 can be changed to adjust the amount of light beam whose traveling direction is converted. Even when the cutout portion is formed in the opposite surface 9 side as shown in FIG. 4B or even when the cutout portions are formed in the light output surface 8 side and the opposite surface 9 side as shown in FIG. 4C, the depth of the cutout portion can be changed to adjust the amount of light beam whose traveling direction is converted.

FIG. 4F shows the case where the light beam direction conversion portion 10 includes a cutout portion which is formed in the light output surface 8 side of the light guide plate 2 and tapered from the light output surface 8. Even in the case where reflecting surfaces are not perpendicular to the light output surface 8, when the reflecting surfaces are located at an angle equal to or smaller than 20.02 degrees relative to the normal to a light emitting surface 7 of the LED 1, the light beam direction conversion portion 10 effectively acts. Even in the cases of the cutout portion of FIG. 4B and the cutout portions of FIG. 4C, when the reflecting surfaces are located at the angle equal to or smaller than 20.02 degrees relative to the normal to the light emitting surface 7, the light beam direction conversion portion 10 effectively acts. FIG. 4G shows the case where the light beam direction conversion portion 10 includes a through hole portion tapered from the light output surface 8. Even in this case, when the reflecting surfaces are located at the angle equal to or smaller than 20.02 degrees relative to the normal to the light emitting surface 7, the light beam direction conversion portion 10 effectively acts.

Next, FIGS. 5A to 5F show plane shape examples of the light beam direction conversion portion, each of which corresponds to the cutout portion or the through hole portion as shown in FIGS. 4A to 4F. FIG. 5A shows an example in which the light beam direction conversion portion includes three surfaces. The light beam direction conversion portion includes two reflecting surfaces 12 for reflecting a light beam. The two reflecting surfaces 12 are provided so that an end of each thereof is brought into contact with a light input surface 11 on which the light beam from the LED 1 is input and an angle α relative to the normal to the light emitting surface 7 of the LED 1 is within 20.02 degrees. The angle α can be controlled to adjust a converted traveling direction of the light beam. A width “b” parallel to the light emitting surface 7 of the LED 1 with respect to the reflecting surfaces 12 becomes narrower than a width “a” of the light emitting surface 7 of the LED 1. When the width “b” is changed, the amount of light beam whose traveling direction is converted can be adjusted. A remaining surface has no light beam direction conversion function because the light beam from the LED 1 is not directly emitted thereto.

FIG. 5B shows an example in which the light beam direction conversion portion includes five surfaces. The light beam direction conversion portion includes the two reflecting surfaces 12 for reflecting the light beam. This structure is different from the structure of FIG. 5A in the point that the light beam direction conversion portion includes two surfaces perpendicular to the light emitting surface of the LED 1. The influence of the surface perpendicular to the light emitting surface of the light source on the light beam is small, so the light beam direction conversion function is not lost. The number of constituent surfaces of the light beam direction conversion portion can be increased without the loss of the light beam direction conversion function. Therefore, the light beam direction conversion portion can be formed in various shapes and the options for a method of producing the light beam direction conversion portion can be increased.

FIG. 5C shows an example in which the light beam direction conversion portion includes five surfaces. The light beam direction conversion portion includes the two reflecting surfaces 12 for reflecting the light beam. This structure is different from the structure of FIG. 5A in the point that the light beam direction conversion portion includes two surfaces, each of which becomes a shadow for the light emitting surface of the LED 1. The influence of the surface which becomes the shadow for the light emitting surface of the light source on the light beam is small, so the light beam direction conversion function is not lost. The number of constituent surfaces of the light beam direction conversion portion can be increased without the loss of the light beam direction conversion function. Therefore, the light beam direction conversion portion can be formed in various shapes and the options for the method of producing the light beam direction conversion portion can be increased.

FIG. 5D shows an example in which the light beam direction conversion portion includes two flat surfaces and a curved surface. The light beam direction conversion portion includes the two reflecting surfaces 12 for reflecting the light beam. The curved surface has no light beam direction conversion function because the light beam from the LED 1 is not directly emitted thereto. Therefore, any curved surface may be provided, so the options for the method of producing the light beam direction conversion portion can be increased.

FIG. 5E shows an example in which the light beam direction conversion portion includes four flat surfaces and a curved surface. The light beam direction conversion portion includes the two reflecting surfaces 12 for reflecting the light beam. Two surfaces perpendicular to the light emitting surface 7 are provided so as to join the two reflecting surfaces and the curved surface. The curved surface is disposed in a region to which the light beam is not directly emitted. The influence of the surface perpendicular to the light emitting surface 7 on the light beam is small, so the light beam direction conversion portion can be formed in various shapes without the loss of the light beam direction conversion function and the options for the method of producing the light beam direction conversion portion can be increased.

FIG. 5F shows an example in which the light beam direction conversion portion includes five surfaces. The light beam direction conversion portion includes the two reflecting surfaces 12 for reflecting the light beam. As shown in FIG. 5F, the two reflecting surfaces are not in contact with each other and an interval is formed between end portions of the two reflecting surfaces. The interval corresponds to a gap provided in the light input surface 11. In this case, when the angle α is set to a value equal to or smaller than 20.02 degrees, the direction conversion on most of the light beam emitted from the light source is performed by the reflecting surfaces. The interval is provided between the end portions of the two reflecting surfaces, that is, the light input surface is formed in a shape to have the gap, so the options for the method of producing the light beam direction conversion portion can be increased.

Even in the cases of the structures shown in FIGS. 5B to 5F, as in the case of the structure shown in FIG. 5A, the end portion of each of the two reflecting surfaces 12 is brought into contact with the light input surface 11 on which the light beam from the LED 1 is input and the angle α relative to the normal to the light emitting surface 7 of the LED 1 is within 20.02 degrees. When the angle α is changed, the converted traveling direction of the light beam can be adjusted. The width “b” which is parallel to the light emitting surface 7 of the LED 1 and formed by the reflecting surfaces 12 becomes narrower than the width “a” of the light emitting surface 7 of the LED 1. When the width “b” is changed, the amount of light beam whose traveling direction is converted can be adjusted.

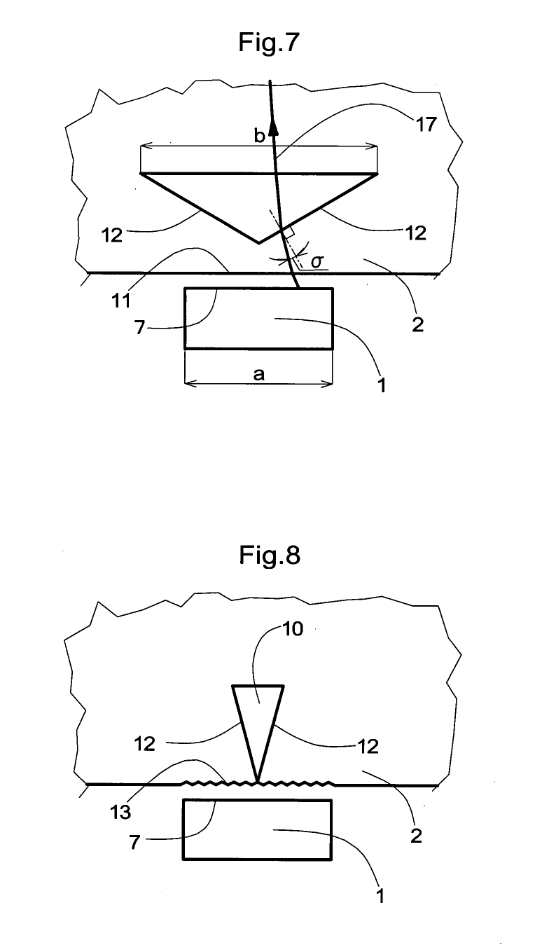

Next, the action of the reflecting surfaces of the light beam direction conversion portion will be described with reference to the drawings. FIG. 6 is a partially enlarged plan view showing a relationship between the LED 1 and the light guide plate 2 in which the cutout portion is provided as the light beam direction conversion portion 10. The comparison with the present invention is also made. FIG. 7 is a partial plan view showing the case where the two reflecting surfaces are provided so that an angle relative to the normal to the light emitting surface of the LED is larger than 20.02 degrees and the width formed by the reflecting surfaces 12 is larger than the width of the light emitting surface 7 of the LED. As shown in FIG. 6, when a light beam 14 emitted from the LED 1 at a light emitting angle γ is input on the light guide plate 2 having a refractive index n, the traveling direction of the light beam 14 is converted into a direction corresponding to an angle β expressed by the numerical expression 1 based on Snell's law. Therefore, the light beam 14 travels as a light beam 15 through an inner portion of the light guide plate 2.

$$β = Arc Sin ( \frac{Sin γ}{n} ) \qquad ( Numerical Expression 1 )$$

As shown in FIG. 6, when the light beam 15 is reflected on the reflecting surface 12 tilted by the angle α relative to the normal to the light emitting surface 7 of the LED 1, the traveling direction of the light beam 15 is converted into a direction corresponding to an angle ε, so the light beam 15 becomes a light beam 16. In this case, the angle ε is obtained by using the following numerical expression 2.
ε=2α+β (Numerical Expression 2)

As described above, the reflecting surface 12 changes the traveling direction of the light beam entering the light guide plate. Because the traveling direction of the light beam is changed, a direction distribution of the light beam traveling through the light guide plate can be adjusted. Therefore, the light beam uniformly travels through the entire light guide plate. When the angle α of the reflecting surface 12 relative to the normal to the light emitting surface of the LED increases, the angle ε of the converted light beam which is obtained by using the numerical expression 2 becomes larger, so an adjustable range of the direction distribution of the light beam can be increased. However, when the angle α of the reflecting surface 12 increases, an angle σ formed between the normal to the reflecting surface 12 and the traveling direction of the light beam becomes smaller. When a value of σ is smaller than a value obtained by using the following numerical expression 3, the light beam is not reflected on the reflecting surface 12 but travels therethrough, with the result that the function of changing the traveling direction of the light beam is not exercised. The light beam traveling through the reflecting surface is input on the light guide plate again. However, the interface reflection is repeated, thereby reducing the efficiency. In order to totally reflect the entire light beam input on the reflecting surface 12, it is necessary to set the angle of the reflecting surface 12 to an angle equal to or smaller than the angle α obtained by using the following numerical expressions 3, 4, and 5.

The numerical expression 3 is used to calculate a minimum angle of the light beam which can be totally reflected on the reflecting surface 12 of the light guide plate having the refractive index n. The numerical expression 3 is derived from Snell's law. Therefore, the light beam at an incident angle smaller than the minimum angle travels through the reflecting surface without the total reflection.

$$σ = Arc Sin ( \frac{Sin 90 °}{n} ) = Arc Sin ( \frac{1}{n} ) \qquad ( Numerical Expression 3 )$$

The numerical expression 4 is used to calculate a maximum angle of the angle β of the converted light beam 15 which is obtained when the light beam 14 from the LED is input on the light guide plate. The numerical expression 4 is derived from Snell's law.

$$β = Arc Sin ( \frac{Sin 90 °}{n} ) = Arc Sin ( \frac{1}{n} ) \qquad ( Numerical Expression 4 )$$

The numerical expression 5 indicates a maximum angle of the reflecting surface at the time of total reflection of the light beam 15 which reaches the reflecting surface 12. That is, when the reflecting surface has an angle larger than the value calculated using the numerical expression 5, the entire light beam input on the reflecting surface cannot be totally reflected. As shown in FIG. 6, the angle α of the reflecting surface 12 is obtained based on the angle β and the angle σ. A maximum value of the angle α of the reflecting surface 12 which totally reflects the entire light beam emitted from the LED is obtained by substituting the maximum angle of the angle β and the minimum value of the angle σ into the numerical expression “α=90°−β−σ” for obtaining the angle α. When the angle of the reflecting surface 12 relative to the normal to the light emitting surface of the LED is smaller than the value of the angle α which is expressed by the numerical expression 5, the entire light beam input on the reflecting surface 12 is reflected.

$$\begin{matrix}α = 90 ° - ( maximum incident angle \\ relative to light guide plate ) - \\ ( minimum incident angle of light \\ beam totally relfected on \\ reflecting surface ) \\ = 90 ° - ( 4 ) - ( 3 ) \\ = 90 ° - Arc Sin ( \frac{Sin 90 °}{n} ) - \\ Arc Sin ( \frac{Sin 90 °}{ n} )\end{matrix} \qquad ( Numerical Expression 5 )$$

In the case of polycarbonate whose refractive index n is 1.59, as is apparent from the numerical expression 5, in order to totally reflect the entire light beam 15 input on the light guide plate, it is necessary to set the angle of the reflecting surface 12 to a value equal to or smaller than 12.06 degrees.

The LED does not uniformly emit the light beam at all angles (in all directions). The amount of light beam reduces as the angle relative to the normal to the light emitting surface of the LED becomes larger. An angle obtained in the case where the amount of light beam is a half of the maximum value thereof is called a half-value angle. In the case of the edge-light illuminating device, an LED is used in which half-value angle relative to the normal to the light emitting surface of the LED is 55 degrees. Most of the light beam is emitted from the LED at an angle equal to or smaller than the half-value angle. Therefore, the reflecting surface 12 preferably reflects the light beam emitted from the LED at the angle equal to or smaller than the half-value angle. In order to totally reflect the entire light beam emitted from the LED at the angle equal to or smaller than the half-value angle, the angle of the reflecting surface 12 is preferably set to an angle equal to or smaller than the angle α obtained by using the numerical expression 3 and the following numerical expressions 6 and 7.

The numerical expression 6 is used to calculate the angle β of the converted light beam 15 which is obtained when the light beam 14 emitted from the LED at a half-value angle of 55 degrees is input on the light guide plate. The numerical expression 6 is derived from Snell's law.

$$β = Arc Sin ( \frac{Sin 55 °}{n} ) \qquad ( Numerical Expression 6 )$$

The numerical expression 7 indicates a maximum angle of the reflecting surface 12 at the time of total reflection of the light beam 15 obtained by the incidence of the light beam emitted from the LED at the angle equal to or smaller than the half-value angle on the light guide plate. As in the description of the numerical expression 5, the maximum value of the angle α of the reflecting surface 12 which totally reflects the light beam which is emitted from the LED at the angle equal to or smaller than the half-value angle and reaches the reflecting surface 12 is obtained by substituting the angle β at the time of the incidence of the light beam from the LED at the half-value angle on the light guide plate and the angle σ corresponding to a minimum incident angle of the light beam totally reflected on the reflecting surface into the numerical expression for obtaining the angle α. When the angle of the reflecting surface 12 relative to the normal to the light emitting surface of the LED is smaller than the value of the angle α which is expressed by the numerical expression 7, the entire light beam which is emitted from the LED at the angle equal to or smaller than the half-value angle and input on the reflecting surface 12 is reflected.

$$\begin{matrix}α = 90 ° - ( incident angle of light \\ beam emitted from LED at half \text{-} \\ value angle on light guide plate ) - \\ ( minimum incident angle of light \\ beam totally reflected on \\ reflecting surface ) \\ = 90 ° - ( Equation 6 ) - ( Equation 3 ) \\ = 90 ° - Arc Sin ( \frac{Sin 55 °}{n} ) - \\ Arc Sin ( \frac{Sin 90 °}{n} )\end{matrix} \qquad ( Numerical Expression 7 )$$

When a material of the light guide plate is polycarbonate whose refractive index n is 1.59, according to the numerical expression 7, the angle α of the reflecting surface 12 at the time when the light beam 15 obtained by the incidence of the light beam emitted from the LED at the half-value angle on the light guide plate is totally reflected on the reflecting surface 12 is 20.02 degrees. Various kinds of materials can be used for the light guide plate. However, it is necessary to select the material of the light guide plate in view of the refractive index. In the case where acrylic whose refractive index n is 1.49 is used as the material of the light guide plate, according to the numerical expression 7, the angle α of the reflecting surface 12 at the time when the light beam 15 obtained by the incidence of the light beam emitted from the LED at the half-value angle on the light guide plate is totally reflected on the reflecting surface 12 is equal to or smaller than 16.91 degrees and thus smaller than the angle α in the case of polycarbonate. Therefore, when the refractive index n of the light guide plate is equal to or smaller than 1.59, the maximum value of the angle α of the light beam reflecting surface 12 relative to the normal to the light emitting surface 7 of the LED 1 is 20.02 degrees.

FIG. 7 shows a schematic structure in which the angle of the reflecting surface 12 relative to the normal to the light emitting surface of the LED is larger than 20.02 degrees and the width “b” of the cutout portion serving as the light beam direction conversion portion is larger than the width “a” of the light emitting surface of the LED. In order that a light beam travels in the direction along the normal to the light emitting surface 7 of the LED 1 in the structure, as in the case of a light beam 17, the light beam is caused to travel through the reflecting surface 12 of the light beam direction conversion portion and enter the light guide plate again. This reduces the efficiency because interface reflection is repeated. As shown in FIG. 5, when the width “b” of the cutout portion serving as the light beam direction conversion portion is set to a value smaller than the width “a” of the light emitting surface 7 of the LED 1, there is a light beam traveling in the direction along the normal to the light emitting surface 7 of the LED 1 without interface reflection, such as a light beam 18 shown in FIG. 6. When the width “b” of the cutout portion is changed, it is possible to adjust a ratio between the amount of light beam reflected on the reflecting surface 12 and the amount of light beam traveling in the direction along the normal to the light emitting surface 7 of the LED 1.

FIG. 8 is an enlarged view showing a structure in which a light diffusion portion 13 is provided in a light input portion of the light guide plate 2. The light diffusion portion 13 has a function for widening an angle range of the light beam input on the light guide plate 2. When the reflecting surfaces 12 and the light diffusion portion 13 are combined with each other, a range capable of controlling a distribution of the light beam traveling through the light guide plate can be widened, so the light beam easily uniformly travels through the light guide plate. That is, the light beam can be uniformly output from the light output surface of the light guide plate, so a sufficient light amount is obtained even at an end portion of the light guide plate. Therefore, a so-called edge area can be reduced. In this case, the angle range of the light beam input on the light guide plate 2 is widened by the light diffusion portion 13, so it is necessary to set the angle of each of the light beam reflecting surfaces 12 relative to the normal to the light emitting surface 7 of the LED 1 to a value smaller than 20.02 degrees to reduce the amount of light beam which is not totally reflected on the reflecting surfaces 12.

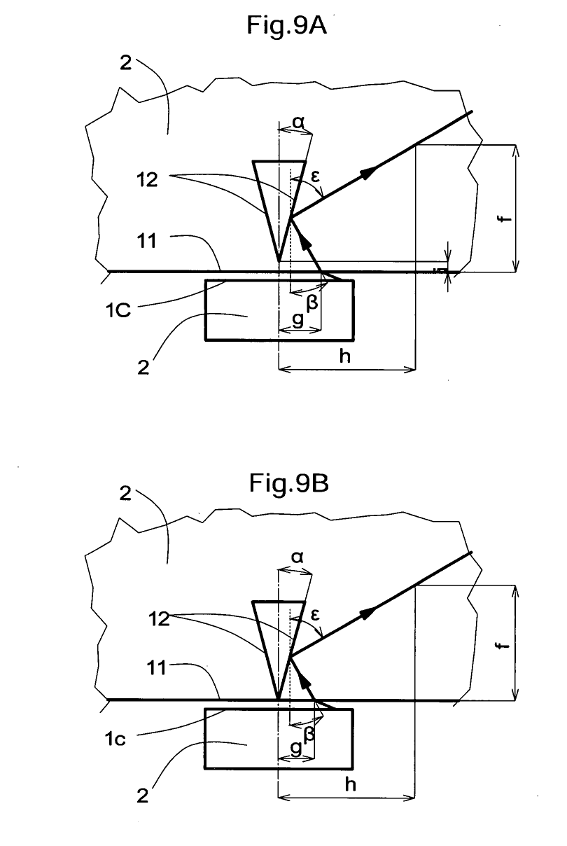

FIGS. 9A and 9B are plan views showing the case where the reflecting surfaces 12 are in contact with the light input surface and the case where the reflecting surfaces 12 are not in contact therewith. In the case where the angle α relative to the normal to the light emitting surface 7 of the LED 1, the angle β of the input light beam, and a width g between an end portion of the reflecting surface 12 and a point at which a light beam is input on the light guide plate are equal in both cases, when the light beam reflected on the reflecting surface 12 reaches a point corresponding to a distance h from the end portion of the reflecting surface 12, a distance f between the point which the light beam reaches and the light input surface is changed by a distance “i” between the light input surface and the end portion of the reflecting surface 12. In order to reduce the edge area, it is necessary to bring the reflecting surfaces 12 into contact with the light input surface.

What is claimed is:

1. An illuminating device comprising:
a light source; and
a light guide plate having:
a light input surface on which the light from the light source is input; and
a light output surface from which the light which is input on the light input surface and guided is output,
wherein the light guide plate includes a light beam direction conversion portion having two reflecting surfaces for reflecting the light from the light source, and
wherein each of the two reflecting surfaces is formed so that an end thereof is brought into contact with the light input surface and an angle relative to a normal to a light emitting surface of the light source is equal to or smaller than 20.02 degrees.

2. An illuminating device according to claim 1, wherein the light beam direction conversion portion has a length in a width direction thereof which is shorter than a width of the light emitting surface of the light source.

3. An illuminating device according to claim 1, wherein the two reflecting surfaces are in contact with each other at the light input surface.

4. An illuminating device according to claim 1,
wherein the light input surface comprises an opening portion formed therein, and
wherein the opening portion includes:
a first end bonded to an end of one of the two reflecting surfaces; and
a second end bonded to an end of the other of the two reflecting surfaces.

5. An illuminating device according to claim 1, wherein the light beam direction conversion portion comprises a cutout portion formed in at least one of the light output surface of the light guide plate and an opposite surface opposed to the light output surface.

6. An illuminating device according to claim 1, wherein the light beam direction conversion portion comprises a through hole portion formed in a thickness direction of the light guide plate.

7. A display device, comprising:
an illuminating device comprising:
a light source; and
a light guide plate having:
a light input surface on which the light from the light source is input; and
a light output surface from which the light which is input on the light input surface and guided is output; and
non-self light emitting display elements provided on a light emitting surface side of the illuminating device,
wherein the light guide plate includes a light beam direction conversion portion having two reflecting surfaces for reflecting the light from the light source, and
wherein each of the two reflecting surfaces is formed so that an end thereof is brought into contact with the light input surface and an angle relative to a normal to a light emitting surface of the light source is equal to or smaller than 20.02 degrees.
